(19) United States
(12) Patent Application Publication
(10) Pub. No.: US 2002/0085596 A1
(43) Pub. Date: Jul. 4, 2002

(54) Optical fiber with holding member, semiconductor laser module and Raman amplifier

(75) Inventors: Yuichiro Irie, Tokyo (JP); Toshio Kimura, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO., LTD., Tokyo (JP)

(21) Appl. No.: 09/981,989

(22) Filed: Oct. 19, 2001

(30) Foreign Application Priority Data
Oct. 19, 2000 (JP) 2000-320110

(51) Int. Cl. H01S 3/04; H01S 3/08; H01S 3/00

(52) U.S. Cl. 372/36; 372/108; 372/102; 359/334

(57) ABSTRACT

An optical fiber with holding member according to the present invention has an optical fiber including a diffraction grating formed therein for reflecting only a laser beam having a predetermined wavelength range, and a ferrule into which the optical fiber is inserted and supported. The portion of the optical fiber on which the diffraction grating is formed extends outwardly beyond the end of the ferrule.

### BACKGROUND OF THE INVENTION

The present invention relates to an optical fiber with holding member, a semiconductor laser module including such an optical fiber with holding member and a Raman amplifier including such a semiconductor laser module. The present invention particularly relates to an optical fiber with holding member, semiconductor laser module and Raman amplifier which can hold an optical fiber in which a diffraction grating such as Fiber Bragg Grating (FBG) is formed.

In the field of semiconductor laser modules used as a pump light source for optical amplifier, it is broadly known that the optical fiber optically coupled with the laser beam from the end of a semiconductor laser element includes a diffraction grating such as FBG or the like formed therein to form an external resonator which controls the oscillating wavelength to a wavelength determined by the diffraction grating.

FIG. 6A is a diagrammatically cross-sectional view of a semiconductor laser module according to the prior art. As shown in FIG. 6A, the semiconductor laser module comprises a semiconductor laser element 50 for emitting a laser beam, an optical fiber 51 for receiving the laser beam emitted from the front facet (right side in FIG. 6A) of the semiconductor laser element 50, the optical fiber 51 including a diffraction grating K, such as FBG or the like, formed therein for reflecting only a laser beam component having a predetermined wavelength range, and a photodiode 52 for receiving a monitoring laser beam emitted from the back facet (left side in FIG. 6A) of the semiconductor laser element.

In front of the semiconductor laser element 50, there are disposed a first lens (collimating lens) 53 for collimating the laser beam from the front facet of the semiconductor laser element 50 and a second lens (condensing lens) 54 for condensing the collimated laser beam.

The laser beam emitted from the front facet of the semiconductor laser element 50 is collimated by the first lens 53 and then condensed by the second lens 54 into the optical fiber 51 from which the beam is externally delivered. Part of the laser beam is reflected b the diffraction grating K in the optical fiber 51. The reflected beam portion is fed back to the semiconductor laser element 50 through the second lens 54 and first lens 53. An external resonator is thus formed between the semiconductor laser element and the diffraction grating K, so that the laser oscillation can be created at a wavelength range determined by the diffraction grating K.

On the other hand, the monitoring laser beam outputted from the back facet of the semiconductor laser element 50 is received by the photodiode 52. When the amount of received beam in the photodiode 52 and the like are calculated, the optical output of the semiconductor laser element 50 can be regulated.

The semiconductor laser module of the prior art has its noise spectrum in which peaks appear at intervals each equal to the frequency determined by the length of the external resonator (or inverse number of time required for the beam to reciprocate in the resonator). For such a reason, the semiconductor laser module of the prior art raised a problem in that the noise characteristic (or relative intensity noise: RIN) was degraded.

Such a problem is true of not only the use of the semiconductor laser module as a signal light source, but also of Raman amplification. This problem will now be described in detail. Raman amplification is a process of amplifying an optical signal by using such a phenomenon that the induced Raman scattering produced when a pump beam enters the optical fiber creates a gain on the frequency side longer than the frequency of the pump beam by about 100 nm and that when a signal beam of a wavelength range having such a gain is inputted into the optical fiber in such a pumped state, that signal beam is amplified. The Raman amplification is characterized by:

(1) that the existing optical fiber can be used as amplifying medium, rather than any special fiber such as erbium-doped fiber; and

(2) that when the wavelength of the pump beam entering the optical fiber is changed, the amplification gain can be obtained at any wavelength, thereby increasing the number of signal beam channels in WDM (Wavelength Division Multiplex).

On the contrary, the Raman amplification is required to have its higher optical output toward the semiconductor laser module since the resultant gain is smaller. The Raman amplification is further required to stabilize the wavelength through the diffraction grating or the like since the variations of the oscillating wavelength vary the gain wavelength range. There is known a technique of substantially reducing RIN by shortening the spacing between the semiconductor laser element and the diffraction grating as short as possible and to prolong the period of noise spectrum such that the peaks will be placed outside of the utility range. In such a case, it is desirable to decrease the noise of the pump beam (RIN) down to −130 dB/Hz or less within a range between 0 and 2 GHz (maybe, between 0 and 22 GHz).

### SUMMARY OF THE INVENTION

The present invention provides an optical fiber with holding member comprising:

an optical fiber including a diffraction grating formed therein at one end, said diffraction grating being adapted to reflect only a beam having a predetermined wavelength range; and

an optical fiber holding member into which said optical fiber is inserted and held, the portion of said optical fiber on which the diffraction grating is formed extending outwardly beyond the end of said optical fiber holding member.

The present invention also provides a semiconductor laser module comprising:

a semiconductor laser element for emitting a laser beam;

an optical fiber for receiving a laser beam emitted from one facet of said semiconductor laser element, said optical fiber including a diffraction grating for reflecting only a laser beam component having a predetermined wavelength range, said diffraction grating being formed in said optical fiber at one end and forming a resonator together with said semiconductor laser element; and

an optical fiber holding member into which said optical fiber is inserted and supported, the portion of said optical fiber on which the diffraction grating is formed extending outwardly beyond the end of said optical fiber holding member.

The present invention further provides a Raman amplifier comprising:

at least one semiconductor laser module, said semiconductor laser module comprising:

a semiconductor laser element for emitting a laser beam;

an optical fiber for receiving a laser beam emitted from one facet of said semiconductor laser element, said optical fiber including a diffraction grating for reflecting only a laser beam component having a predetermined wavelength range, said diffraction grating being formed in said optical fiber at one end and forming a resonator together with said semiconductor laser element; and

an optical fiber holding member into which said optical fiber is inserted and supported, the portion of said optical fiber on which the diffraction grating is formed extending outwardly beyond the end of said optical fiber holding member; and

an amplifying optical fiber for transmitting a signal beam, said amplifying optical fiber being adapted to combine a pump beam emitted from said semiconductor laser module with the signal beam transmitted through said amplifying optical fiber for giving a Raman gain to said signal beam.

### BRIEF DESCRIPTION OF THE DRAWINGS

FIG. 1 is a cross-sectional view of an optical fiber with holding member constructed in accordance with a first embodiment of the present invention.

FIG. 2 is a cross-sectional view of an optical fiber with holding member constructed in accordance with a second embodiment of the present invention.

FIG. 3 is a cross-sectional view of a semiconductor laser module constructed in accordance with a third embodiment of the present invention.

FIG. 4 is a cross-sectional view of a semiconductor laser module constructed in accordance with a fourth embodiment of the present invention.

FIG. 5 is a block diagram of a Raman amplifier constructed in accordance with a fifth embodiment of the present invention.

FIG. 6A is a diagrammatically cross-sectional view of a semiconductor laser module constructed in accordance with the prior art while

FIG. 6B is a cross-sectional view showing the internal structure of a ferrule.

### DETAILED DESCRIPTION

Several embodiments of the present invention will now be described in comparison with the prior art with reference to the drawings.

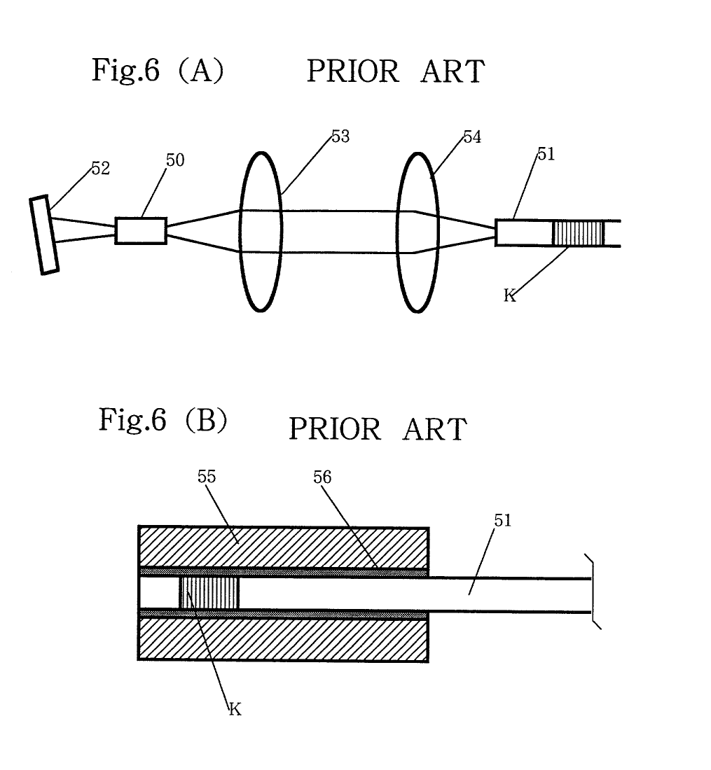

FIG. 6B is a cross-sectional view showing the internal structure of a ferrule used in a semiconductor laser module according to the prior art. As shown in FIG. 6B, it is known, in the semiconductor laser module of the prior art, that a diffraction grating K may be formed in an optical fiber 51 at the tip end thereof and that the diffraction grating K may be disposed in the interior of a ferrule 50 holding the optical fiber 51 on the side of a semiconductor laser element 50, thereby reducing the spacing between the semiconductor laser element 50 and the diffraction grating K. Such an arrangement is preferred from the viewpoint of noise reduction. One of such semiconductor laser modules is disclosed, for example, in Japanese Patent Laid-Open Application No. Hei 8-286077.

However, the optical fiber 51 including the diffraction grating K is fixedly mounted in the interior of the ferrule 55 through adhesive or solder 56 which has its larger coefficient of thermal expansion. Therefore, the diffraction grating K will be stressed by the thermal expansion of the adhesive or solder on variations of the ambient temperature. This varies the oscillating wavelength of the laser beam. If the semiconductor laser module of the prior art is used as a pump beam in the Raman amplifier, therefore, the Raman gain varies on variations of the ambient temperature. This does not provide a stable gain.

Therefore, the present invention provides an optical fiber with holding member, semiconductor laser module and Raman amplifier which can have a better noise characteristic and which can reduce the wavelength variation of the laser beam due to changes of the ambient temperature.

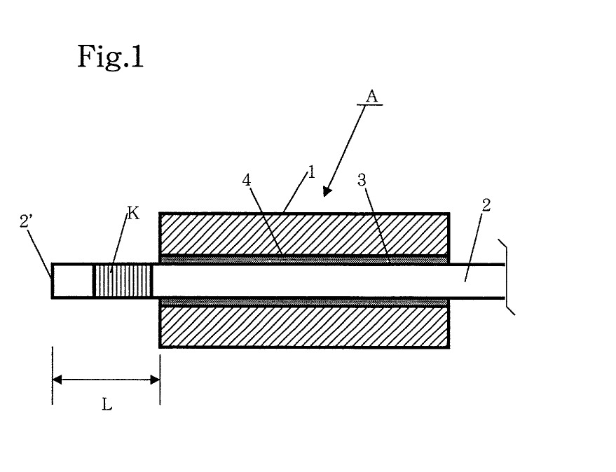

FIG. 1 is a cross-sectional view of an optical fiber with holding member A constructed in accordance with a first embodiment of the present invention.

Referring to FIG. 1, the optical fiber with holding member A comprises an optical fiber 2 and a ferrule (or sleeve) 1 which is an optical fiber holding member for holding the optical fiber 2. The ferrule 1 is formed of any material selected from a group consisting of stainless steel, Fe—Co—Ni alloy, ceramic and composites thereof. The ferrule 1 includes an insert aperture 3 formed therethrough for receiving the optical fiber 2.

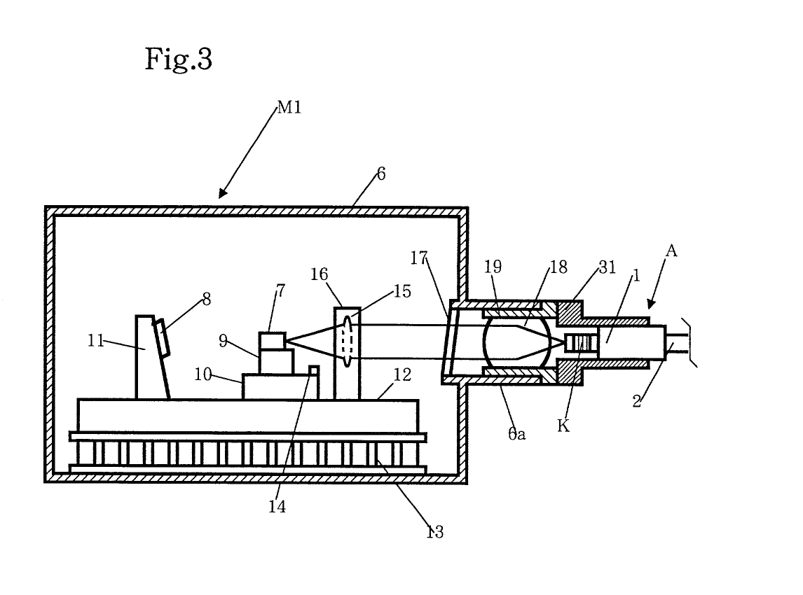

The diffraction grating K is formed in the optical fiber 2 at the tip end thereof to extend in the axial direction and adapted to reflect only a laser beam component having a predetermined wavelength range in the laser beam emitted from a semiconductor laser element 7 (see FIG. 3). The diffraction grating K may be formed to change the refractive index thereof when the core portion of the optical fiber 2 is irradiated by an interference fringe-shaped ultra-violet light through a phase mask, for example.

After the diffraction grating K has been formed in the optical fiber 2 at the tip end thereof, an end face 2′ is formed in the optical fiber 2 at the forwardmost tip through cleavage using an optical fiber cutter. The end face 2′ is flat and usually in a plane perpendicular to the longitudinal axis of the optical fiber. From the viewpoint of preventing the light from returning back to the semiconductor laser element 7, however, it is preferable that the end face 2′ is cut slantly relative to the longitudinal axis of the optical fiber.

The optical fiber 2 is inserted into the insert aperture 3 formed in the ferrule 1 and fixedly held by the ferrule 1 through adhesive or solder 4. With use of the solder, the outer periphery of the optical fiber 2 has been covered with a plated layer. The tip portion of the optical fiber 2 including the diffraction grating K extends outwardly from the end of the ferrule 1 on the side of the semiconductor laser element 7. The distance L between the end of the ferrule 1 and the end face 2′ of the optical fiber 2 is preferably equal to or smaller than 3 mm from the viewpoint of the stability in optical coupling. It is further preferred that the end face 2′ of the optical fiber 2 on the side of the semiconductor laser element 7 is coated with any anti-reflection coat (AR coat).

According to the first embodiment of the present invention, the portion of the optical fiber 2 in which the diffraction grating K is formed extends outwardly beyond the end of the ferrule 1 on the side of the semiconductor laser element 7. Thus, the laser beam outputted from the resonator formed by the semiconductor laser element 7 and the diffraction grating K can have a better noise characteristic. Moreover, even if the adhesive or solder 4 for the optical fiber 2 is thermally expanded by the variation of the ambient temperature to stress the optical fiber 2, the portion of the optical fiber 2 in which the diffraction grating K is formed will not be influenced by the thermal expansion of the optical fiber 2. This can prevent any variation in the oscillating wavelength of the laser beam.

Although the prior art abraded the end of the ferrule 1 as well as the end face 2′ of the optical fiber to be flat, this embodiment of the present invention forms the end face 2′ of the optical fiber through cleavage. Thus, the abrading step is not required, thereby shortening the manufacturing time (manufacturing process).

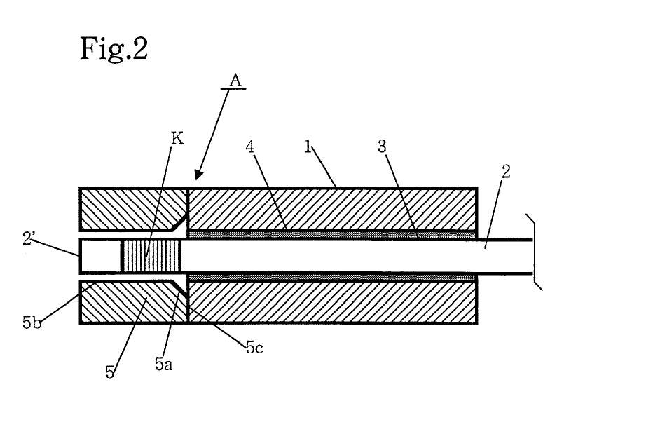

FIG. 2 is a cross-sectional view of an optical fiber with holding member A constructed in accordance with a second embodiment of the present invention. As shown in FIG. 2, the second embodiment provides a swinging width regulating member 5 located on the end of the ferrule 1 on the side of the semiconductor laser element 7, the member 5 being adapted to regulate the swinging width in the tip end of the optical fiber 2 on which the diffraction grating K is formed. The swinging width regulating member 5 may be formed of any material selected from a group consisting of metals, ceramics and composites thereof and is fixedly mounted on the end of the ferrule 1 through YAG laser welding, soldering or adhesive.

The swinging width regulating member 5 is in the form of a cylindrical member for holding the optical fiber 2 in loose fit. Since the swinging width regulating member 5 is thus not fixed to the optical fiber 2 through adhesive or solder, the diffraction grating K in the optical fiber 2 will not be stressed by the thermal expansion of the adhesive or solder.

The swinging width regulating member 5 includes a through-aperture 5b through which the optical fiber 2 extends, the diameter of the through-aperture 5b being substantially equal to that of the optical fiber 2.

However, a predetermined gap is formed between the inner wall of the through-aperture 5b in the swinging width regulating member 5 and the outer periphery of the optical fiber 2 so as not to stress the optical fiber 2 through the thermal expansion of the swinging width regulating member 5.

In order to prevent the swinging width regulating member S from being engaged by the proximal end of the extended portion of the optical fiber 2 when the swinging width regulating member 5 is deviated, a notch 5a may be formed in the inner wall of the proximal end 5c of the swinging width regulating member 5.

According to the second embodiment, the swinging action at the tip end of the optical fiber 2 can highly be prevented to maintain the laser oscillation stable since the swinging width regulating member 5 for regulating the swinging width at the tip end of the optical fiber 2 on which the diffraction grating k is formed is provided on the end of the ferrule 1 on the side of the semiconductor laser element 7.

FIG. 3 is a cross-sectional view of a semiconductor laser module constructed in accordance with a third embodiment of the present invention. As shown in FIG. 3, the semiconductor laser module M1 comprises a hermetically sealed package 6; a semiconductor laser element 7 housed in the package 6 for emitting a laser beam; an optical fiber with holding member A according to the first embodiment, comprising an optical fiber 2 for receiving the laser beam from the front facet (right side in FIG. 3) of the semiconductor laser element 7 and externally delivering it out of the package 6, the optical fiber 2 being formed with a diffraction grating K for reflecting only a laser beam component having a predetermined wavelength range, and a ferrule 1 for holding the optical fiber 2; and a photodiode 8 for receiving the monitoring laser beam emitted from the back facet (left side in FIG. 3) of the semiconductor laser element 7. In place of the optical fiber with holding member A according to the first embodiment, the optical fiber with holding member A of the second embodiment including the swinging width regulating member 5 formed therein on the end thereof may be used.

The semiconductor laser element 7 is fixedly mounted on a heat sink 9 which is in turn fixedly mounted on a chip carrier 10.

The photodiode 8 is fixedly mounted on a photodiode carrier 11. The chip and photodiode carriers 10, 11 are mounted on a base 12, below which a cooling device 13 consisting of Peltier device is located. The raised temperature due to heat from the semiconductor laser element 7 is sensed by a thermistor 14 on the chip carrier 10. The cooling device 13 is controlled to maintain the temperature sensed by the thermistor 14 constant. Thus, the laser output of the semiconductor laser element 7 can be stabilized.

In front of the semiconductor laser element 7 on the base 12, there is located a first lens 15 for collimating the laser beam emitted from the semiconductor laser element 7. The first lens 15 is held by a first lens holder 16 on the base 12.

The package 6 includes a flange 6a formed thereon at one side. The flange 16a contains a window 17 for receiving the laser beam after passed through the first lens 15 and a second lens 18 for condensing the laser beam. The second lens 18 is held by a second lens holding member 19 which is fixedly mounted in the outer end of the flange 6a through YAG laser welding. The outer end of the second lens holding member 19 fixedly supports a metallic sleeve 31 through YAG laser welding. The sleeve 31 is YAG laser welded to the outer end of the second lens holding member after the sleeve 31 has properly been positioned in a plane perpendicular to the optical axis of the optical fiber 2.

The optical fiber 2 is held by the ferrule 1 which is in turn fixedly mounted in the sleeve 31 through YAG laser welding. Thus, the optical fiber 2 is firmly positioned in the direction of optical axis (Z-axis).

The laser beam emitted from the front facet of the semiconductor laser element 7 is collimated by the first lens 15 and condensed by the second lens 18 into the end face 2′ of the optical fiber 2 held by the ferrule 1 before the laser beam is externally delivered through the optical fiber 2. Part of the laser beam is reflected by the diffraction grating K in the optical fiber 2. The reflected laser beam component is fed back to the semiconductor laser element 7 through the second lens 18 and first lens 15, thereby creating an external resonator between the semiconductor laser element 7 and the diffraction grating K. In such a manner, the laser oscillation can be made at a wavelength range which is determined by the reflection profile in the diffraction grating K.

On the other hand, the monitoring laser beam emitted from the back facet of the semiconductor laser element 7 is received by the photodiode 8. By calculating the amount of received beam at the photodiode 8, the optical output of the semiconductor laser element 7 can be regulated.

The optical system for optically coupling the laser beam from the front facet of the semiconductor laser element 7 with the optical fiber 2 is not limited to such a two-lens system as described, but may be in the form of a condensing one-lens system.

According to the third embodiment, the optical fiber with holding member A which is constructed according to the first or second embodiments and in which the portion of the optical fiber on which the diffraction grating K is formed extends outwardly beyond the outer end of the ferrule 1 is used. Therefore, the oscillating wavelength of the laser beam can be prevented from being varied due to change of the ambient temperature, thereby stabilizing the wavelength of the outputted laser beam.

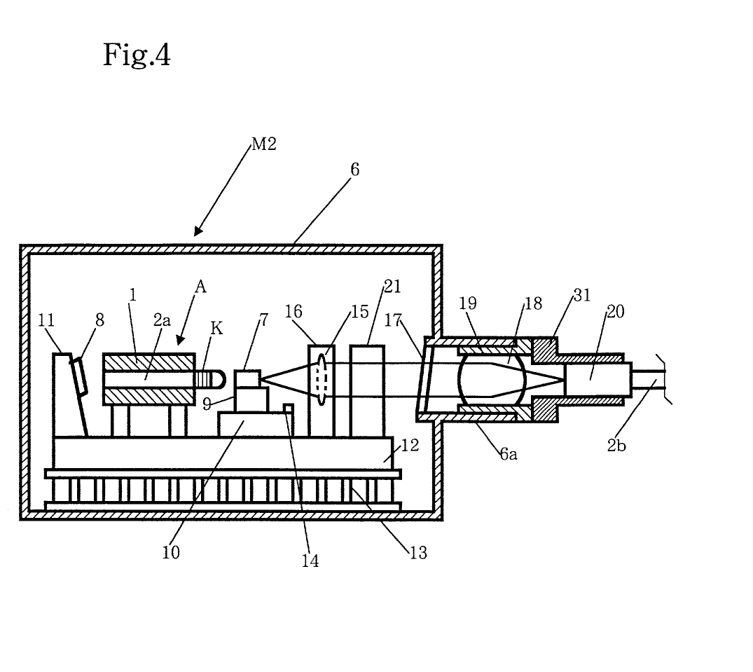

FIG. 4 is a cross-sectional view of a semiconductor laser module according to the fourth embodiment of the present invention. As shown in FIG. 4, the semiconductor laser element M2 comprises the optical fiber with holding member A according to the first embodiment, the member A including a first optical fiber 2a having its lensed tip end and the diffraction grating K for receiving the laser beam emitted from the back facet (left side in FIG. 4) of the semiconductor laser element 7 and for reflecting only the laser beam having a predetermined wavelength range and a ferrule 1 for holding the first optical fiber 2a; and a second optical fiber 2b for receiving and externally delivering the laser beam emitted from the front face (right side in FIG. 4) of the semiconductor laser element 7. In place of the optical fiber with holding member A according to the first embodiment, there may be used the optical fiber with holding member A according to the second embodiment, which includes the swinging width regulating member 5 at the outer end. The second optical fiber 2b is held by a ferrule 20 which is in turn fixedly mounted in the sleeve 31 through YAG laser welding.

Since the first optical fiber 2a including the diffraction grating K is disposed between the semiconductor laser element 7 and the photodiode 8, the optical resonance occurs between the front facet of the semiconductor laser element 7 and the diffraction grating K of the first optical fiber 2a to emit the laser beam from the front facet of the semiconductor laser element 7 at a predetermined wavelength.

Between the semiconductor laser element 7 and the second delivering optical fiber 2b, there is located an optical isolator 21 for blocking any reflective beam returned from the second optical fiber 2b.

According to the fourth embodiment, the first optical fiber 2a including the diffraction grating K is disposed behind the semiconductor laser element 7 so that the first optical fiber 2a is optically coupled with the semiconductor laser element 7 through the lens formed in the first optical fiber 2a at its tip end. Therefore, the spacing between the semiconductor laser element 7 and the diffraction grating K can greatly be reduced to shift the noise spectrum of the laser beam from the semiconductor laser element 7 toward the side of higher frequency.

Moreover, the semiconductor laser element 7 can be operated in a stable manner and the absolute value of RIN can be decreased, since the optical isolator 21 for blocking the reflective beam returned from the second optical fiber 2b can be inserted between the semiconductor laser element 7 and the second delivering optical fiber 2b.

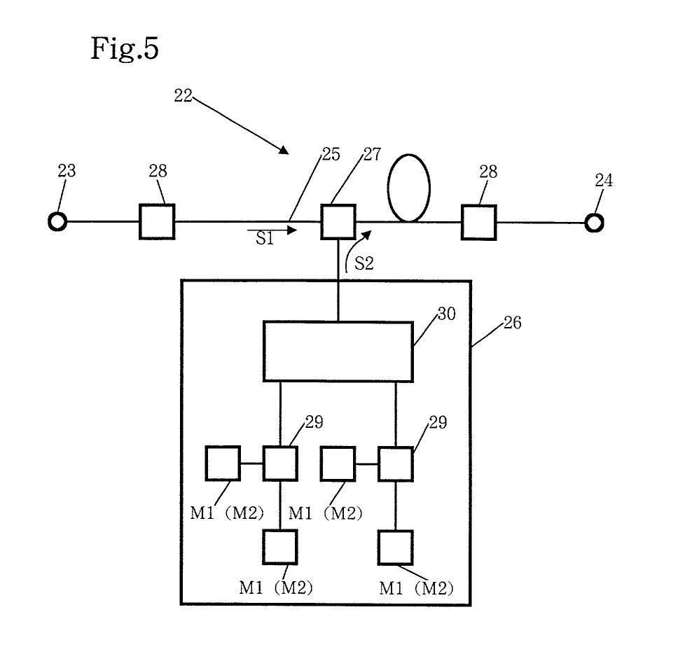

FIG. 5 is a block diagram of a Raman amplifier according to the fifth embodiment of the present invention. As shown in FIG. 5, the Raman amplifier 22 comprises an input portion 23 for receiving a signal beam S1, an output portion 24 for outputting the signal beam S1, an amplifying optical fiber 25 for transmitting the signal beam S1 between the input and output portions 23, 24, a pump beam generating portion 26 for generating a pump beam S2, and a WDM coupler 27 for combining the pump beam S2 generated by the pump beam generating portion 26 with the signal beam S1 transmitted toward the amplifying optical fiber 25. Optical isolators 28 for transmitting only the signal beam S1 directed from the input portion 23 toward the output portion 24 are located between the input portion 23 and the WDM coupler 27 and between the output portion 24 and the WDM coupler 27, respectively.

The pump beam generating portion 26 comprises the semiconductor laser modules M1 and M2 according to the third or fourth embodiment of the present invention, polarized-wave combining couplers 29 for cross polarizing and combining the laser beams emitted from the respective semiconductor laser modules M1 and M2 and having the same wavelength, and a WDM coupler 30 for combining the output beams from the respective polarized-wave combining couplers 29. The cross polarizing and combining in the polarized-wave combining couplers 29 is to reduce the degree of polarization (DOP) and to provide a higher output since the Raman amplification gain has the polarized-wave dependency.

To reduce the DOP, it is also effective that part of the optical fiber for transmitting the laser beam emitted from the semiconductor laser element 7 is formed by a polarized light holding fiber which has its polarized light holding axis inclined relative to the polarized light axis of the laser beam by 45°.

The pump beams S2 emitted from the semiconductor laser modules M1, M2 and having the same wavelength are polarized-wave combined by the respective polarized-wave combining couplers 29. The output beams from the respective polarized-wave combining couplers 29 are combined by the WDM coupler 30 and then outputted from the pump beam generating portion 26.

The pump beam generated by the pump beam generating portion 26 is coupled with the amplifying optical fiber 25 by the WDM coupler 27. On the other hand, the signal beam S1 inputted through the input portion 23 is combined with the pump beam S2 and amplified by the amplifying optical fiber 25. The amplified beam passes through the WDM coupler 27 before it is outputted through the output portion 24.

Since the Raman amplifier 22 according to the fifth embodiment of the present invention uses the semiconductor laser modules M1 and M2 which have reduced noise and provide the pump beam S2 having its stable wavelength even when the ambient temperature is variable, it can provide a desired and stable Raman gain with reduced noise even when the ambient temperature is variable.

The present invention is not limited to the aforementioned embodiments, but may be changed and modified in any forms without departing from the spirit and scope of the invention as defined in the appending claims.

1. An optical fiber with holding member comprising:
an optical fiber including a diffraction grating formed therein at one end, said diffraction grating being adapted to reflect only a beam having a predetermined wavelength range; and
an optical fiber holding member into which said optical fiber is inserted and held, the portion of said optical fiber on which the diffraction grating is formed extending outwardly beyond the end of said optical fiber holding member.

2. The optical fiber with holding member according to claim 1 wherein the end of said optical fiber holding member includes a swinging width regulating member for regulating the swinging width in the portion of said optical fiber on which the diffraction grating is formed.

3. The optical fiber with holding member according to claim 1 wherein said diffraction grating is a fiber bragg grating.

4. A semiconductor laser module comprising:
a semiconductor laser element for emitting a laser beam;
an optical fiber for receiving a laser beam emitted from one facet of said semiconductor laser element, said optical fiber including a diffraction grating for reflecting only a laser beam component having a predetermined wavelength range, said diffraction grating being formed in said optical fiber at one end and forming a resonator together with said semiconductor laser element; and
an optical fiber holding member into which said optical fiber is inserted and supported, the portion of said optical fiber on which the diffraction grating is formed extending outwardly beyond the end of said optical fiber holding member.

5. The semiconductor laser module according to claim 4, further comprising a further optical fiber for receiving and externally delivering the laser beam emitted from the other facet of said semiconductor laser element.

6. The semiconductor laser module according to claim 4 wherein said diffraction grating is a fiber bragg grating.

7. A Raman amplifier comprising:
at least one semiconductor laser module, said semiconductor laser module comprising:
a semiconductor laser element for emitting a laser beam;
an optical fiber for receiving a laser beam emitted from one facet of said semiconductor laser element, said optical fiber including a diffraction grating for reflecting only a laser beam component having a predetermined wavelength range, said diffraction grating being formed in said optical fiber at one end and forming a resonator together with said semiconductor laser element; and
an optical fiber holding member into which said optical fiber is inserted and supported, the portion of said optical fiber on which the diffraction grating is formed extending outwardly beyond the end of said optical fiber holding member; and
an amplifying optical fiber for transmitting a signal beam, said amplifying optical fiber being adapted to combine a pump beam emitted from said semiconductor laser module with the signal beam transmitted through said amplifying optical fiber for giving a Raman gain to said signal beam.

8. The Raman amplifier according to claim 7 wherein said diffraction grating is a fiber bragg grating.
